(19) United States
(12) Patent Application Publication
(10) Pub. No.: US 2012/0209823 A1
(43) Pub. Date: Aug. 16, 2012

(54) METHOD AND SYSTEM FOR MANAGING DATABASE ACCESS CONTENTION

(75) Inventor: Tochukwu Iwuchukwu, Mountain View, CA (US)

(73) Assignee: NOKIA CORPORATION, Espoo (FI)

(21) Appl. No.: 13/026,959

(22) Filed: Feb. 14, 2011

(51) Int. Cl. G06F 17/30; G06F 7/00

(52) U.S. Cl. 707/704; 707/705; 707/E17.044

(57) ABSTRACT

A method comprises receiving an access request for a database table; selecting a table from two or more tables corresponding to the requested database table; and providing access according to the access request to the selected table. The selecting is based on a type of access request and a designation of the selected table corresponding to the type of access request.

### TECHNICAL FIELD

The present application relates generally to database access. More particularly, the present invention relates to management of database access contention.

### BACKGROUND

Current database systems support concurrent access to data with a lock mechanism. For example, in order to obtain read access for a database resource, a read lock must be obtained. In this regard, read access may be provided concurrently to multiple requests since read locks do not conflict with each other. In order to update a database resource or to otherwise obtain write access, a write lock must be obtained. Unlike read access, write access cannot be provided concurrently to more than one request for the same resource. For example, two write processes cannot modify the same resource concurrently. Further, a write process cannot modify a resource while there are existing processes reading the same resource. Thus, a write lock conflicts with another write lock or any read lock on the same database resource. When a process attempts to acquire a conflicting lock for a database resource, the process is required to wait until the already acquired lock is released.

### SUMMARY

Various aspects of examples of the invention are set out in the claims.

According to a first aspect of the present invention, a method comprises receiving an access request for a database table; selecting a table from two or more tables corresponding to the requested database table; and providing access according to the access request to the selected table. The selecting is based on a type of access request and a designation of the selected table corresponding to the type of access request.

According to a second aspect of the present invention, an apparatus comprises at least one processor; and at least one memory including computer program code, the at least one memory and the computer program code configured to, with the at least one processor, cause the apparatus to perform at least the following: receiving an access request for a database table; selecting a table from two or more tables corresponding to the requested database table; and providing access according to the access request to the selected table. The selecting is based on a type of access request and a designation of the selected table corresponding to the type of access request.

According to a third aspect of the present invention, a computer-readable medium includes computer executable instructions which, when executed by a processor, cause an apparatus to perform at least the following: receiving an access request for a database table; selecting a table from two or more tables corresponding to the requested database table; and providing access according to the access request to the selected table. The selecting is based on a type of access request and a designation of the selected table corresponding to the type of access request.

### BRIEF DESCRIPTION OF THE DRAWINGS

For a more complete understanding of example embodiments of the present invention, reference is now made to the following descriptions taken in connection with the accompanying drawings in which:

FIGS. 1-4 illustrate various access requests for a database resource;

FIG. 5 illustrates a database arrangement in accordance with one embodiment;

FIG. 6 illustrates the management of access request contention for the database arrangement of FIG. 5 in accordance with one embodiment;

FIG. 7 is a flow chart illustrating a process of access request contention management in accordance with an embodiment;

FIG. 8 illustrates the management of access request contention for a database arrangement in accordance with another embodiment;

FIG. 9 is an overview diagram of a system within which various embodiments may be implemented; and

FIG. 10 is a schematic representation of the circuitry which may be included in an exemplary electronic device which may be utilized in accordance with the various embodiments.

### DETAILED DESCRIPTION OF THE DRAWINGS

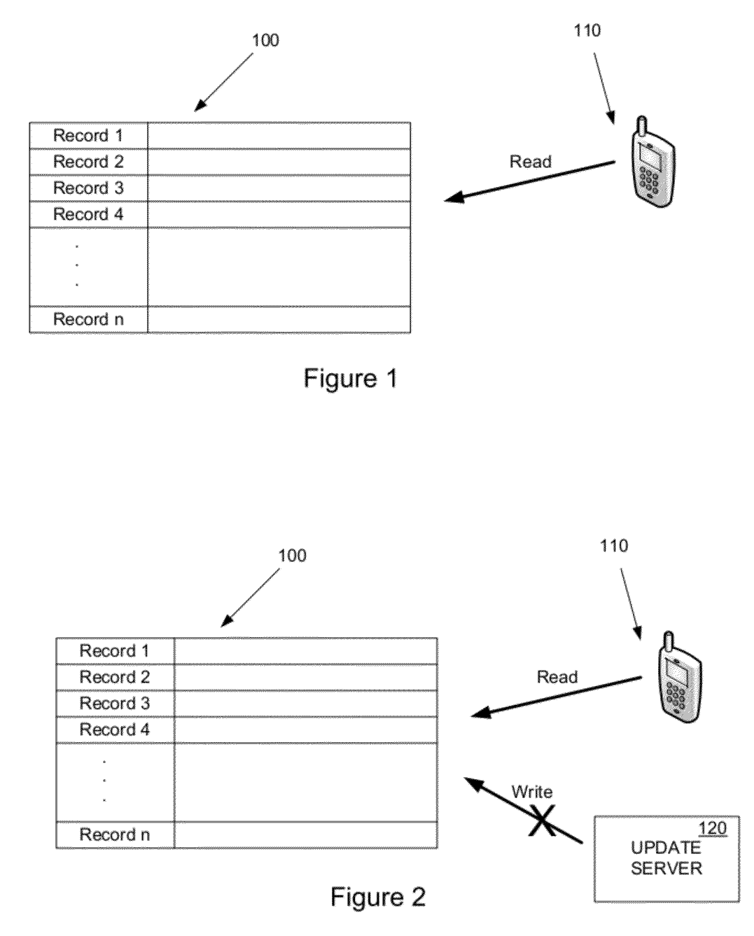

Example embodiments of the present invention and their potential advantages are understood by referring to FIGS. 1-10 of the drawings.

As described above, current database systems support concurrent access to data with a lock mechanism. As illustrated in FIG. 1, a database resource, such as a database table 100, may be accessible by a variety of requestors, such as a mobile device 110. Those skilled in the art will appreciate that various other devices may access the database table 100, such as laptops, desktops, smartphones, personal digital assistants or the like. In the illustration of FIG. 1, the mobile device 110 is requesting read access for the database table 100. It will be understood by those skilled in the art that the request may be received by a server or another computer/storage device to which the database resource is coupled. In order to obtain read access for the database table 100, the mobile device 110 obtains a read lock.

Referring now to FIG. 2, while the mobile device has a read lock for the database table 100, the database table 100 is unavailable for conflicting requests. In particular, as illustrated in FIG. 2, if a device, such as an update server 120, attempts to obtain write access to the database table 100 (for example, to update the information in the database table), the request for write access (or a write lock) is unavailable. The update server 120 must wait until the mobile device 110 releases the read lock for the database table 100.

The locks for the database resource may be provided at various granularities. For example, while FIGS. 1 and 2 illustrate that the read lock obtained by the mobile device 100 locks an entire table, in other cases, the locks may be provided for individual records, as illustrated in FIGS. 3 and 4. In this regard, the mobile device 110 obtains a read lock for records 1 and 2, and a second mobile device 112 may obtain a read lock for records 2 and 3. As illustrated in FIG. 4, when the server 120 attempts to obtain write locks for records 3 and 4, only record 4 is available. The write lock for record 3 must wait until the second mobile device 112 releases the read lock for that record.

Various granularities have advantages and disadvantages. For example, coarse granular locks, such as the table locks illustrated in FIGS. 1 and 2, are well suited for environments having a small number of processes accessing shared resources or environments having short lock times. Coarse locks can result in better performance since the number of locks that must be acquired is reduced (e.g., acquiring a table lock for a large table compared to acquiring a lock for each record in the table). Finer granular locks, such as the record locks illustrated in FIGS. 3 and 4, are more suited for environments having a large number of processes accessing a shared resource since finer granular locks reduce the chances of conflicting locks being requested for the same resource.

In either fine granularities or coarse granularities, the read locks and write locks present difficulties in providing ready access to the database resource to all users. This is illustrated by the following practical example.

As an example, a map client application running on a mobile device is considered. The map client is configured to retrieve real-time map-related information (e.g., traffic) from a database server. In this regard, a large number of users (e.g., thousands or millions) may access the real-time map-related information.

The database server is involved in two classes of processes. The first class of processes comprise a single bulk-update process that periodically fetches real-time traffic data from an external source and updates the real-traffic information in a database table that contains a record for every road segment in, for example, the United States and selected European countries. The second class of processes comprise multiple read processes associated with the clients making requests for real-time traffic data from the server. In order to provide accurate data, it may be desirable to perform frequent updates. However, updates and the read requests represent conflicts for the database resource.

As an example, assume that at time t, the bulk-update process is active and attempting to update the entire database table. In such a case, one of the following occurs:

1. The bulk-update process successfully acquires a table lock, blocking out all incoming read processes. During the update process, no client can retrieve real-time traffic data (i.e., no read access available). The read access for users is not available until the update process has completed its task.

2. The bulk-update process fails to acquire a table lock and must wait until all the active read processes have finished reading data from the database table. If there are many of these read processes, then by the time the bulk-update process can update the table, the traffic information to be updated may become stale. Also, while it is waiting to update the table, the active read processes may be retrieving data that is not current.

3. The bulk-update process acquires a lock for each record in the table as the records become available. This can take a long time for a large table since the update must wait for any conflicts for each record to be resolved before it can move on to the next record.

Embodiments of the present invention can improve performance, concurrency and scalability for systems and applications where there are many client processes reading data from a database and a bulk-update server process periodically updating the information in that database.

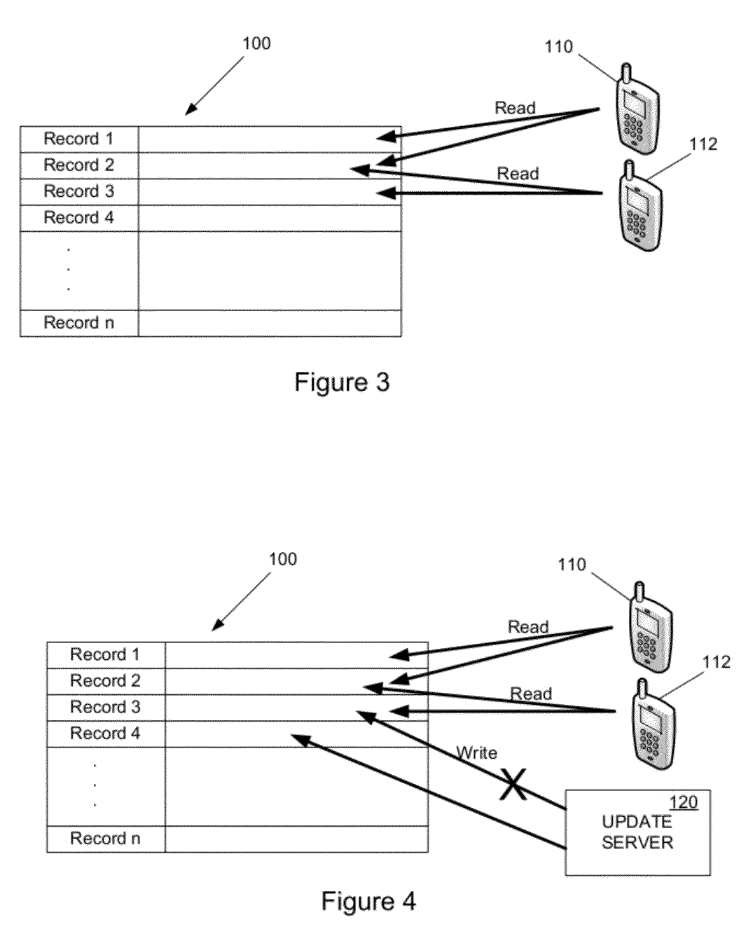

Referring to FIG. 5, a database arrangement in accordance with one embodiment is illustrated. In the illustrated embodiment, a dual-table arrangement is provided. The database arrangement 200 includes two tables, Table 1 210 and Table 2 220. Table 1 210 contains a series of records, and Table 2 220 contains the same records. Each of Tables 1 and 2 contains a “read table” parameter 212, 222. In the illustrated embodiment, the “read table” parameter has a value that is one bit in length. The value of the “read table” parameter indicates whether the table is currently available for access for read processes. For example, as illustrated in FIG. 5, the table having a “read table” value of “0” (Table 1) indicates that Table 1 is available for use by read processes, and the table having a “read table” value of “1” (Table 2) indicates that Table 2 is available for use by bulk-update process.

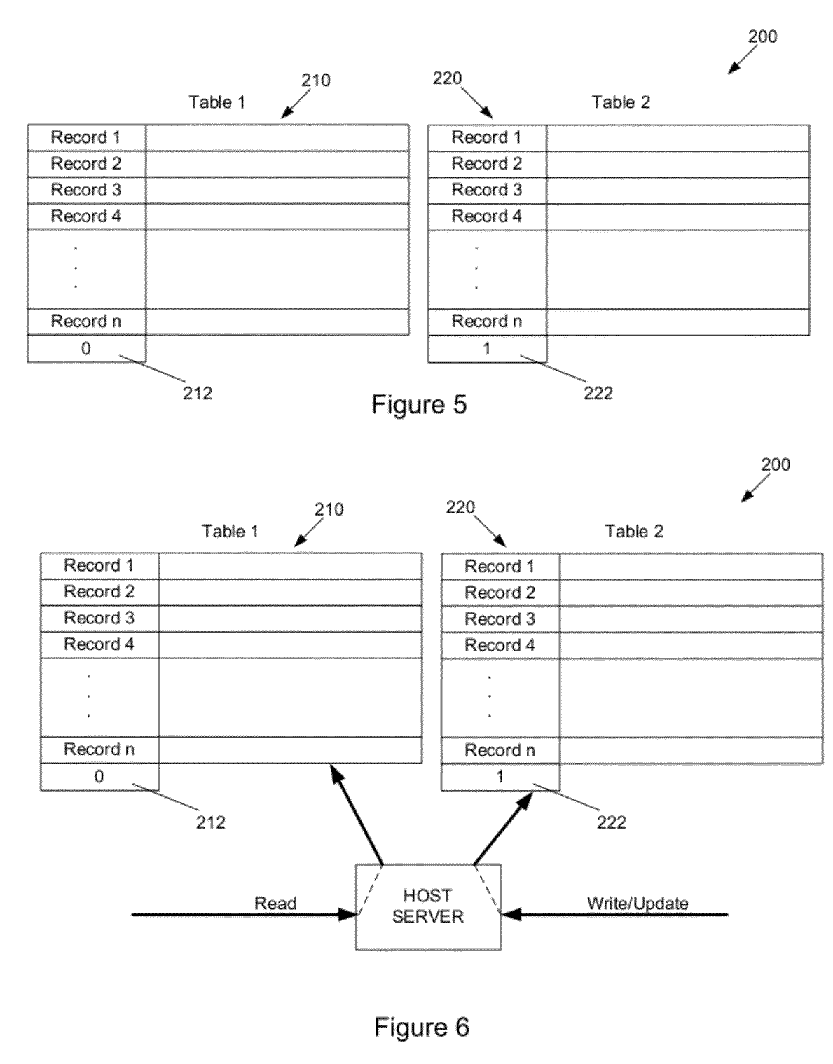

Thus, as illustrated in FIG. 6, when a server associated with the database arrangement 200 receives a read request, or a request for read lock, the request is directed to Table 1. Similarly, when the server receives an update request, or a request for a write lock, the request is directed to Table 2. As described below, after a bulk update, a transition process may result in swapping of the roles of the two tables. In this regard, the values of the “read table” parameters in each of Tables 1 and 2 may be swapped. Thus, the updated table may be made available for read requests to provide users with updated information.

In another embodiment, instead of a “read table” parameter value being a part of each table, a “read table value” may be provided in a storage medium (e.g., memory) of the server. In this regard, the “read table value” indicates which table is used for read processes. For example, a “read table” value of 0 indicates that the table to be used by a read process is Table 1, and a “read table” value of 1 indicates that the table to be used by a read process is Table 2. Similarly, based on the “read table” value, the server directs a bulk-update process to the correct table to update. A “read table” value of 0 indicates that the table to be used by the bulk-update process is Table 2, and a “read table” value of 1 indicates that the table to be used for a bulk-update process is Table 1. Hence, read processes or the bulk-update process simply check the value of the “read table” bit to determine which table to use without acquiring any locks or causing any contention in data access.

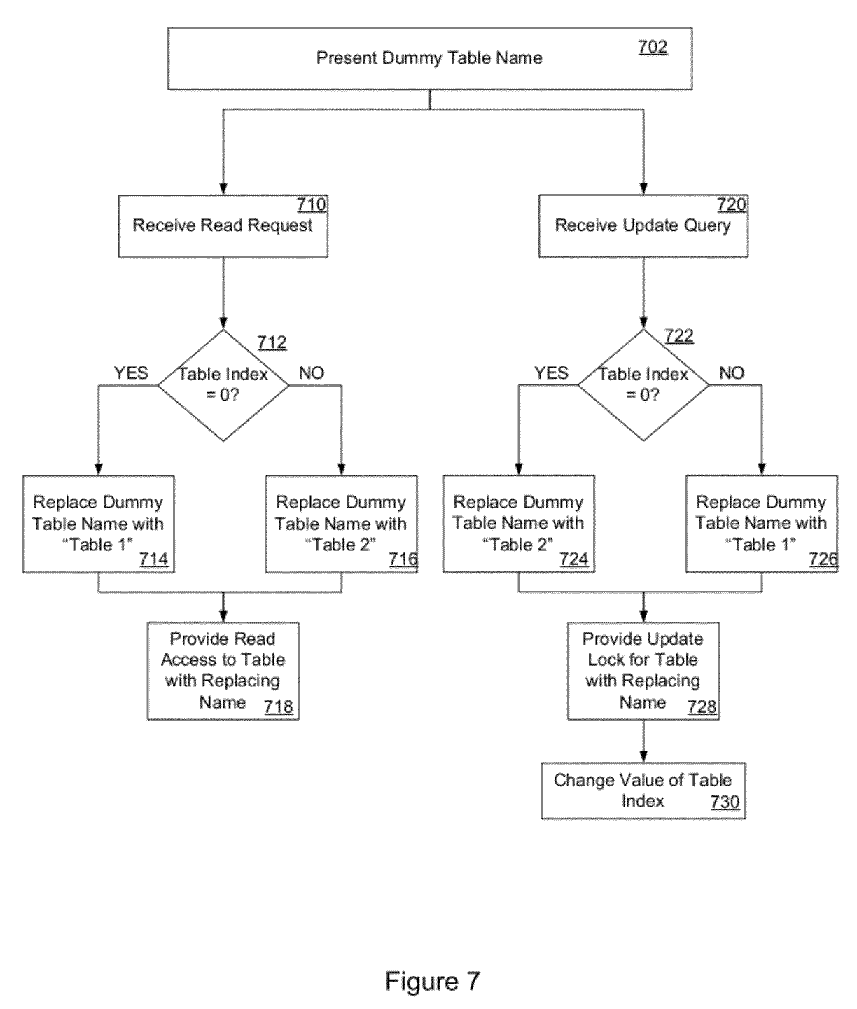

An exemplary implementation of this embodiment comprises a server, an update process and multiple clients that issue read requests to the server to retrieve data. The example implementation is described below with reference to the example flow chart of FIG. 7. On server start-up, the server creates two database tables, TABLE1 and TABLE2, and populates both tables with identical data. The server also maintains a variable in memory called “read_table_index” that is initially set to 0. The server exposes a dummy table name, “DUMMY,” to the update process and clients (block 702). Thus, neither the update process nor clients have any knowledge of TABLE1 or TABLE2 and only issue requests for the dummy table.

When the server receives a client request to read data from “DUMMY” (block 710), the server checks the value of “read_table_index” (block 712). If the value is 0, the server changes the name “DUMMY” in the database read query to “TABLE1” (block 714). Similarly, if the value of “read_table_index” is 1, the server changes the name “DUMMY” in the database query to “TABLE2” (block 716). The server then executes the query on the database and returns the query results to the client (block 718).

When the server receives a database update query from the update process (block 720), the server checks the value of “read_table_index” (block 722). If the value of “read_table_index” is 0, the server changes the name “DUMMY” in the database update query to “TABLE2” (block 724), and if the value of “read_table_index” is 1, the server changes the name “DUMMY” in the database query to “TABLE1” (block 726). The server then executes the updates on the appropriate table (block 728).

Once the update process is completed, the updated table has the latest information which should now be made available to the users requesting read access to the database. In this regard, the server changes the value of “read_table_index” (block 730). For example, if the value of “read_table_index” before the update was 0, the value of “read_table_index” is changed to 1. Further, all new read accesses are directed to the newly updated table.

In one embodiment, the bulk update process updates the entire table. Thus, even if only certain records in the table may change, the entire table is updated. In this regard, all records in the updated table are current.

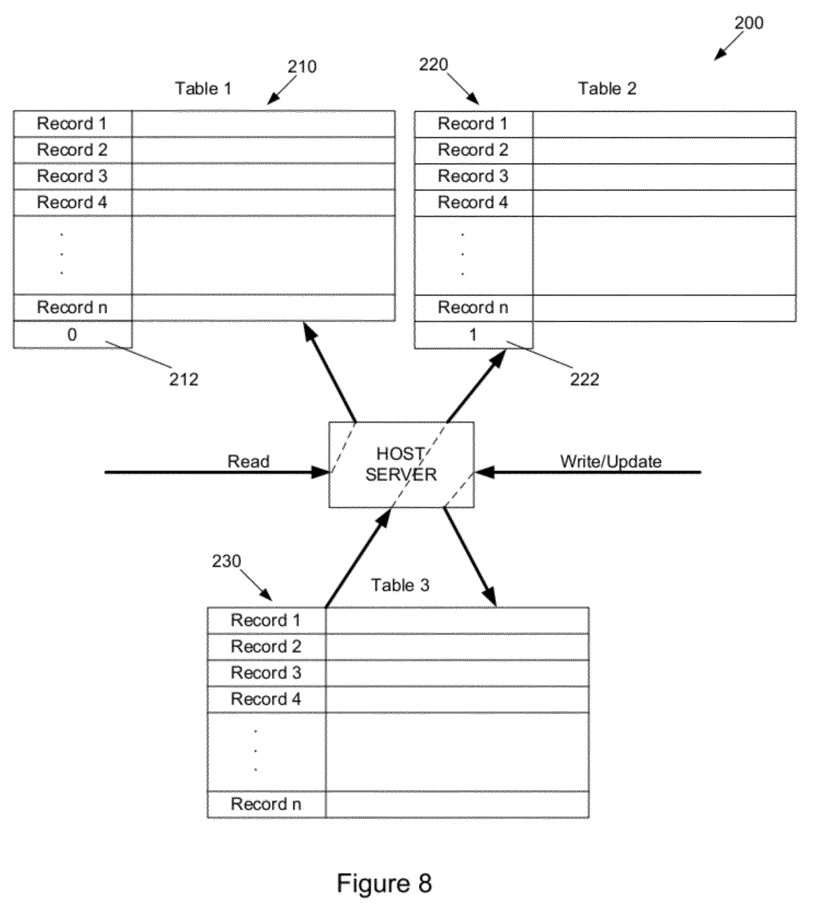

In another embodiment, the bulk update process may update only those records which have changed since the previous update. In order to accommodate this, embodiments of the invention make use of a third table, as illustrated by way of example in FIG. 8. In this regard, at the outset, all three tables 210, 220, 230 are populated with identical data. One of tables 1 and 2 is made available for read access requests. In the example of FIG. 8, Table 1 210 is provided for read access requests. The bulk update process updates Table 3 230. In this regard, the bulk update process may update the entire table or only certain records of Table 3 230. For example, the bulk update process may update only those records which have changed since the last update. Table 3 230 is then copied to Table 2 220, and all subsequent read access requests are directed to Table 2 220.

During a subsequent update cycle, the bulk update process again updates Table 3 230, or certain records of Table 3 230. Thus, the changes made to Table 3 are relative to the previous update with only the records changing since the previous update being updated. Table 3 230 is then copied to Table 1 210, and all subsequent read access requests are directed to Table 1 210. Thus, both Table 3 230 and the table to which the read access requests are currently directed to have up-to-date information.

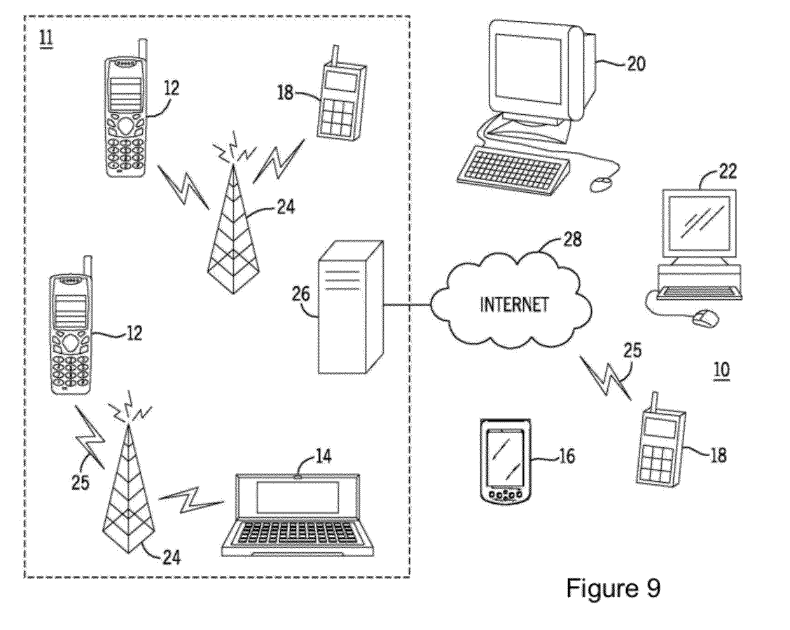

FIG. 9 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 9 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

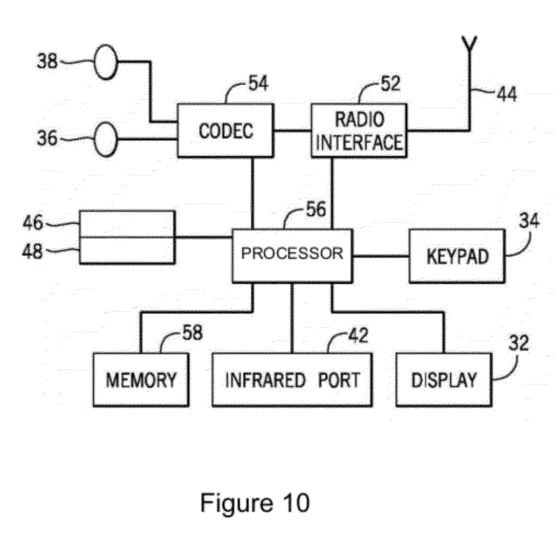

FIG. 10 shows one representative electronic device which may be used in accordance to the various embodiments of the present invention. In embodiments of the present invention, the device of FIG. 10 may be representative of a client device, a streaming server or a network device. It should be understood, however, that the scope of the present invention is not intended to be limited to one particular type of device. The electronic device of FIG. 10 may includes a housing, a display in the form of a liquid crystal display, a keypad 34, a microphone 36, an ear-piece 38, a battery, an infrared port 42, an antenna 44, a smart card 46 in the form of a UICC according to one embodiment, a card reader 48, radio interface circuitry 52, codec circuitry 54, one or more processors, such as processor 56, and one or more memories, such as memory 58. The above described components enable the electronic device to send/receive various messages to/from other devices that may reside on a network in accordance with the various embodiments of the present invention. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Various embodiments may comprise a computer-readable medium including computer executable instructions which, when executed by a processor, cause an apparatus to perform the methods and processes described herein.

Embodiments of the present invention may be implemented in software, hardware, application logic or a combination of software, hardware and application logic. The software, application logic and/or hardware may reside on a client device, a server or a network component. If desired, part of the software, application logic and/or hardware may reside on a client device, part of the software, application logic and/or hardware may reside on a server, and part of the software, application logic and/or hardware may reside on a network component. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 10. A computer-readable medium may comprise a computer-readable storage medium that may be any media or means that can contain or store the instructions for use by or in connection with an instruction execution system, apparatus, or device, such as a computer. In one embodiment, the computer-readable storage medium is a non-transitory storage medium.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
receiving an access request for at least a portion of a database table;
selecting a table from two or more tables corresponding to the requested database table; and
providing access according to the access request to the at least a portion of the selected table,
wherein the selecting is based on a type of access request and a designation of the selected table corresponding to the type of access request.

2. The method of claim 1, wherein the type of access request is either a read access or a write access.

3. The method of claim 2, wherein the designation of the selected table is read lock for a read access and write lock for a write access.

4. The method of claim 1, wherein the designation is determined by a value of a field in the table.

5. The method of claim 1, wherein the designation is determined by a value of a parameter stored on a server associated with the database table.

6. The method of claim 1, wherein the type of access request is a write access, and
wherein the method further comprises:
upon completion of a write procedure associated with the write access, swapping designation of the selected table with one or more of the two or more tables.

7. The method of claim 6, wherein the swapping comprises:
directing all subsequent read access requests to the selected table.

8. An apparatus, comprising:
at least one processor; and
at least one memory including computer program code, the at least one memory and the computer program code configured to, with the at least one processor, cause the apparatus to perform at least the following:
receiving an access request for at least a portion of a database table;
selecting a table from two or more tables corresponding to the requested database table; and
providing access according to the access request to the at least a portion of the selected table,
wherein the selecting is based on a type of access request and a designation of the selected table corresponding to the type of access request.

9. The apparatus of claim 8, wherein the type of access request is either a read access or a write access.

10. The apparatus of claim 9, wherein the designation of the selected table is read lock for a read access and write lock for a write access.

11. The apparatus of claim 8, wherein the designation is determined by a value of a field in the table.

12. The apparatus of claim 8, wherein the designation is determined by a value of a parameter stored on a server associated with the database table.

13. The apparatus of claim 8, wherein the type of access request is a write access, and
wherein the at least one memory and the computer program code are configured to, with the at least one processor, cause the apparatus to further perform at least the following:
upon completion of a write procedure associated with the write access, swapping designation of the selected table with one or more of the two or more tables.

14. The apparatus of claim 13, wherein the swapping comprises:
directing all subsequent read access requests to the selected table.

15. A computer-readable medium including computer executable instructions which, when executed by a processor, cause an apparatus to perform at least the following:
receiving an access request for at least a portion of a database table;
selecting a table from two or more tables corresponding to the requested database table; and
providing access according to the access request to the at least a portion of the selected table,
wherein the selecting is based on a type of access request and a designation of the selected table corresponding to the type of access request.

16. The computer-readable medium of claim 15, wherein the type of access request is either a read access or a write access.

17. The computer-readable medium of claim 16, wherein the designation of the selected table is read lock for a read access and write lock for a write access.

18. The computer-readable medium of claim 15, wherein the designation is determined by a value of a field in the table.

19. The computer-readable medium of claim 15, wherein the designation is determined by a value of a parameter stored on a server associated with the database table.

20. The computer-readable medium of claim 15, wherein the type of access request is a write access, and
wherein the computer executable instructions which, when executed by a processor, cause an apparatus to further perform at least the following:
upon completion of a write procedure associated with the write access, swapping designation of the selected table with one or more of the two or more tables.
